(19) United States
(12) Patent Application Publication
(10) Pub. No.: US 2009/0266563 A1
(43) Pub. Date: Oct. 29, 2009

(54) METHOD, SYSTEM, AND APPARATUS FOR LARGE SCALE OUTDOOR FIRE RETARDATION

(76) Inventors: Thomas Wright, Queen Creek, AZ (US); William Tomes, San Marcos, CA (US)

Correspondence Address: MERLE W. RICHMAN, III, P.O. BOX 3333, LA JOLLA, CA, 92038, US

(21) Appl. No.: 12/211,772

(22) Filed: Sep. 16, 2008

Related U.S. Application Data
(60) Provisional application No. 61/048,139, filed on Apr. 25, 2008.

(51) Int. Cl. A62C 35/00

(52) U.S. Cl. 169/13

(57) ABSTRACT

Embodiments of retarding fire damage to multiple outdoor structures. Other embodiments may be described and claimed.

### CROSS REFERENCE TO RELATED APPLICATIONS

The present application claims the benefit of priority to U.S. Provisional Application No. 61/048,139, entitled “METHOD, SYSTEM, AND APPARATUS FOR LARGE SCALE OUTDOOR FIRE RETARDATION,” filed on Apr. 25, 2008, the entirety of which is incorporated by reference.

### TECHNICAL FIELD

Various embodiments described herein relate generally to outdoor fire impedance or retardation, including architecture, systems, and methods used in outdoor fire retardation.

### BACKGROUND INFORMATION

It may be desirable to protect multiple outdoor structures from fire damage. The present invention provides a system, method, and apparatus for limiting fire damage to multiple outdoor structures.

### BRIEF DESCRIPTION OF THE DRAWINGS

FIGS. 1 and 2 are diagrams of outdoor fire retardation architecture according to various embodiments.

FIG. 3 is a partial top diagram of a pump station according to various embodiments.

FIG. 4 is partial sectional diagram of a pump station and tank according to various embodiments.

FIG. 5 is a partial side diagram of a pump station according to various embodiments.

FIG. 6 is a diagram a multiple sprinkler configuration according to various embodiments.

FIGS. 7A and 7B are partial diagrams of sprinklers according to various embodiments.

FIG. 8 is a flow diagram illustrating a processing algorithm according to various embodiments.

FIG. 9 is a block diagram of an article according to various embodiments.

### DETAILED DESCRIPTION

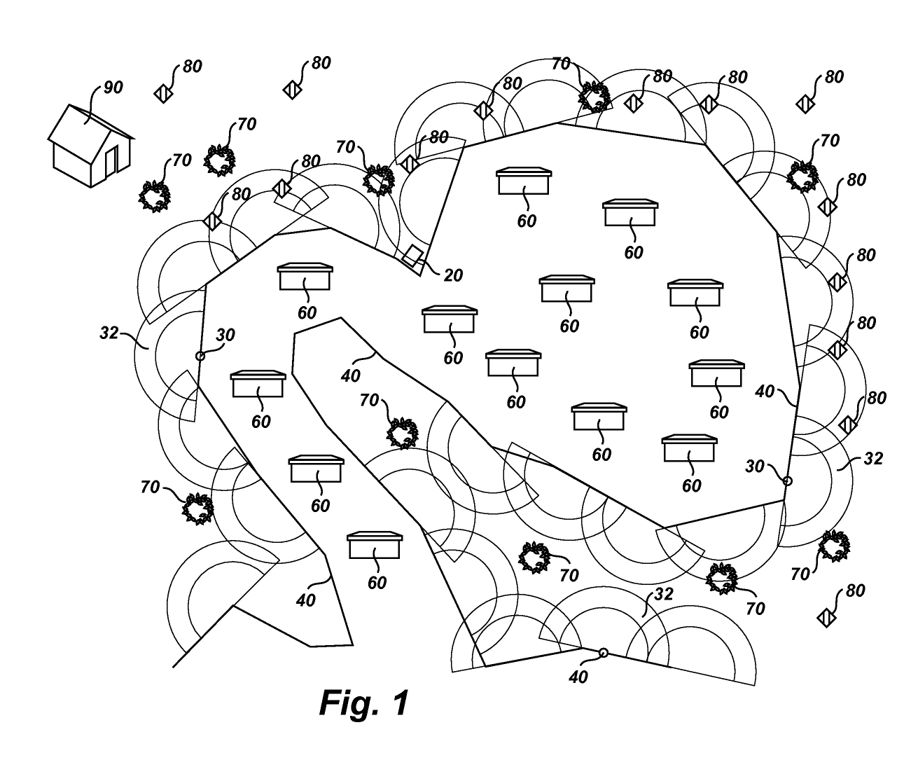

FIG. 1 is a partial diagram of partial outdoor fire retardation architecture 10 according to various embodiments. The architecture 10 includes at least one fire activation center or system 20 and a plurality of sprinklers 30 coupled to the system 20 via pipes 40. The fire retardation system 20 further includes a plurality of fire detection sensors 80. In an embodiment the sprinklers 30 are between open, fire fuel ridden open areas 70 and multiple structures 60. The open areas 50 may include natural fire fuel such as bush, trees or other vegetation 70 or man-made flammable objects including other structures 60.

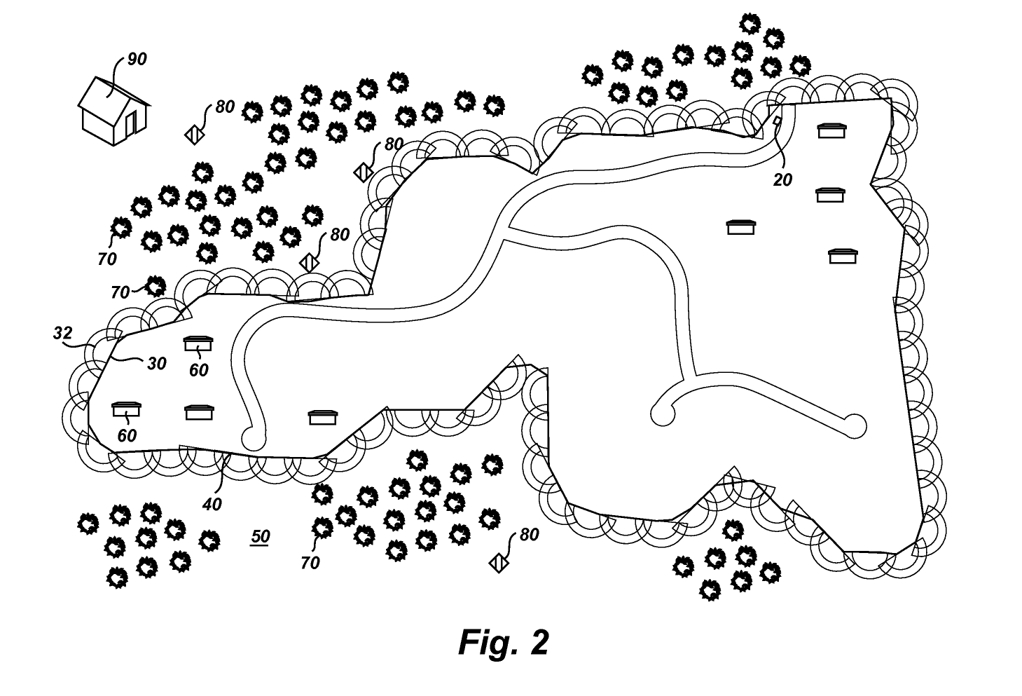

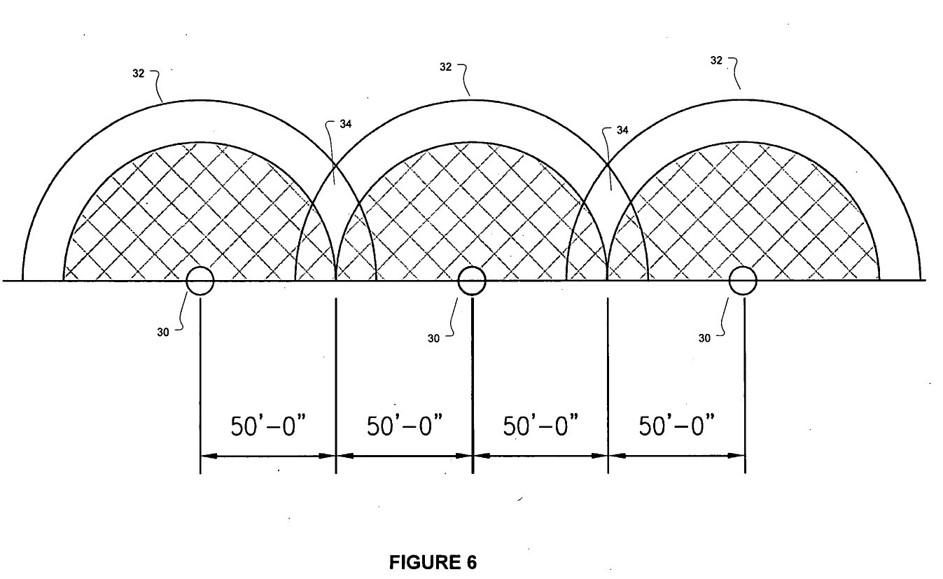

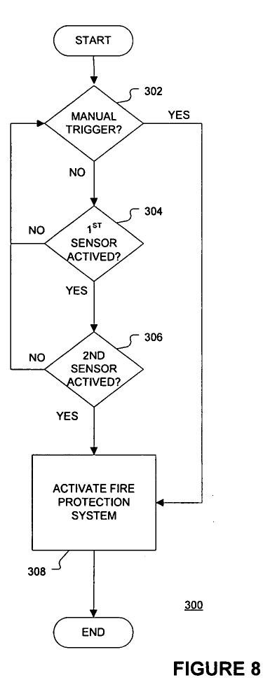

In an embodiment the sprinklers 30 are placed so their output overlaps 34 (see FIG. 6) and completely envelopes the multiple structures 60 to be protected (architecture 100 in FIG. 2). In an embodiment a storage tank 170 loaded with sprayable fire retardation material that may be sprayed in the perimeter surrounding the multiple structures 60 via the sprinklers 30 to obstruct the passage of fire from open areas 50 to the multiple structures 60 upon a trigger-able event. In an embodiment, the system 20 may employ algorithm 300 of FIG. 8 to activate the underlying system 20. A fire department 90 official, occupant of structure 60, or other person or authorized individual may transmit a manual trigger to the system 20 via a wireless or wired connection including analog or digital techniques (activity 302).

Upon receipt of a manual trigger (activity 302) the system 20 may trigger the release of the fire retardant material via the sprinklers 30 for a predetermined time interval (activity 308). In an embodiment the system 20 may disperse 3-15 gallons of fire retardant material per 100 square feet, as a function of the environment, topology, wind conditions (surface area versus density), vegetation height and type, and slope. The released or dispersed material may retard or reduce the spread of fire including non-symmetric fire by reducing the support of potential fuel covered by the retardant. The fire retardant material may be any material that retards the spread of fire by reducing the combustibility of supporting fuel (such as vegetation). The fire retardant material may be a non-chemically based fire retardant material including water or a chemically based fire retardant including Pros-Chek(r), which is produced by ICL Performance Products LP (http://phoschek.com) and other retardants including foam and gel based retardants. The system 20 may apply at least a 50 foot minimum area of the fire retardant to create a potential fire break around a zone such as a community or multiple structures 60, single large structure, large developed or undeveloped zone or region of portion of perimeter (large zoo, power lines, military base) to be protected.

In an embodiment the system 20 may include 500-200,000 linear feet of distribution piping 40, one or more 8000-250000 gallon storage tanks or towers 170, and a plurality of 30 to 150 gallon per minute (GPM) sprinklers 30. For example, the piping 40 may extend around a 1000 foot perimeter and the storage tank 90 may hold about 45,000 gallons of fire retardant material and be capable of disbursing about 50 GPM via each sprinkler 30 where the sprinklers are spaced about 50 feet apart along the 7000 foot perimeter.

It is noted that the tank 170 may be located below ground in an appropriate container, above ground, or substantially above ground enabling a gravity feed system. In an embodiment the storage tank 170 may be a cement tank with an internal epoxy, a steel tank, a lined steel tanks, a fiberglass tank, or a polyethylene or polypropylene tank. In an embodiment the fire detection sensors 80 may be placed at or near the piping 40. The fire detection sensor 80 may include a temperature, gas (such as CO), or optically based sensor including an ultraviolet/infra-red (UV/IR) flame detector sensor 80. Further satellite based systems or sensors may be employed to trigger the fire protection system 308.

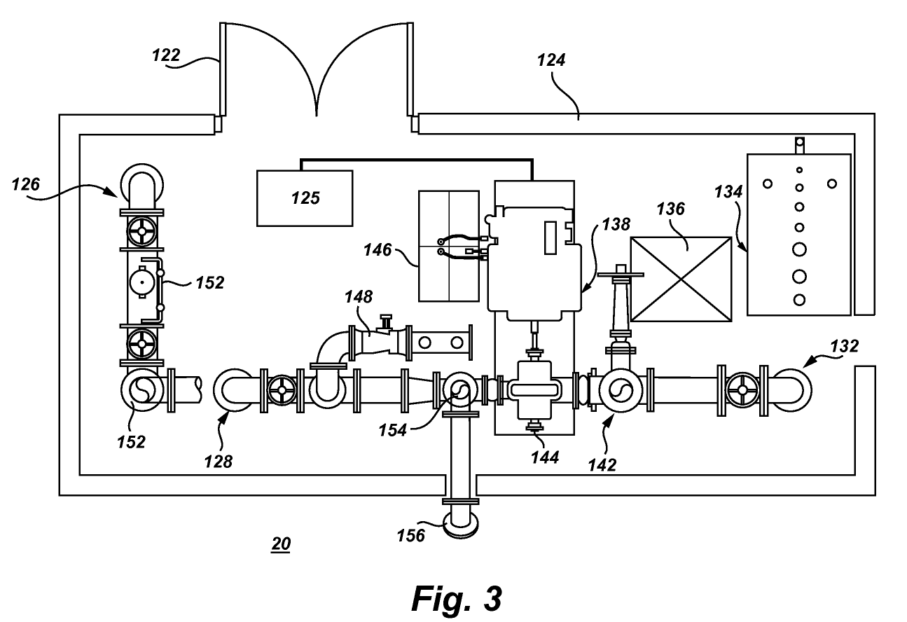

In the algorithm 300 when a first sensor 80 is triggered (activity 304), the algorithm may require a second sensor 80 to be triggered (activity 306) before activating fire retardant distribution (activity 308). FIG. 3 is a partial top view of a pump station 20 according to various embodiments. The pump station 20 may include a controller 125, a motor 138, a fuel tank 134, a local water supply inlet 126, supply out to piping (40) 128, a battery rack 146, an automatic air release valve 162, flow meter 148, access hatch to tank 136, a double backflow prevention device 152, a clean-out valve 154, a clean-out outlet 156, a valve 142, a tank inlet 132, and a motor impeller 144. In an embodiment the pump may be a 250 to 5000 GPM pump with 50 to 200 psi pressure. The pump may include an electric or fuel based motor or engine. The fuel may include diesel, bio-fuel, propane, natural gas, or other flammable or combustible liquid or gases.

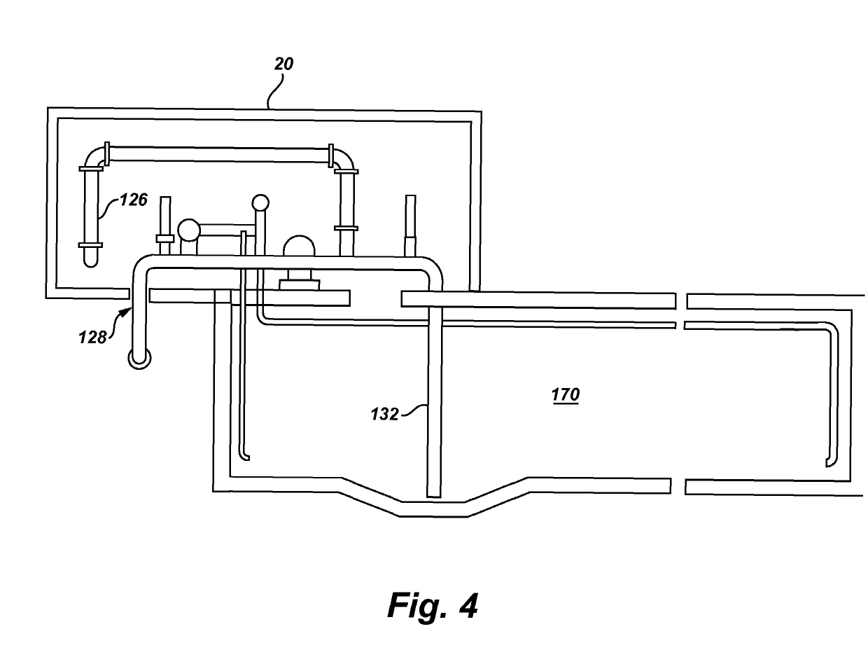

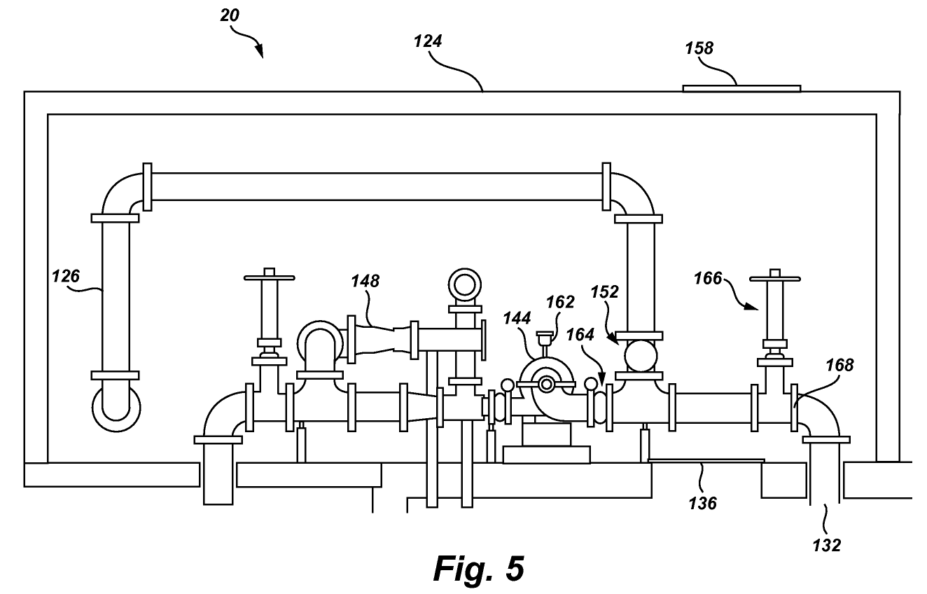

The pump station 20 may be equipped fire proof doors 122 and a cement or other non-combustible walled frame 124 to enable the pump station 20 to withstand fire/heat at or near the pump station. The pump station 20 may enable water supplied by a water company or local municipality to be pumped through the system 20 piping 40 to the sprinklers 30. Water may be pumped through the system 20 to flush the system 10 or sprinklers 30 or apply water to the area around the sprinklers 30. FIG. 4 is side, partial view of the pump station 20 coupled to an underground storage tank 170. The pump system 20 may be coupled to the storage tank 170 via the intake line 132. FIG. 5 is a partial side diagram of the pump system 20 and depicts the local water supply line 126, flow meter 148, automatic release valve 162, flex hose, neoprene 164, access to tank 136, city water valve 152 and release valve. One or more valves may be coupled via a suction based flange.

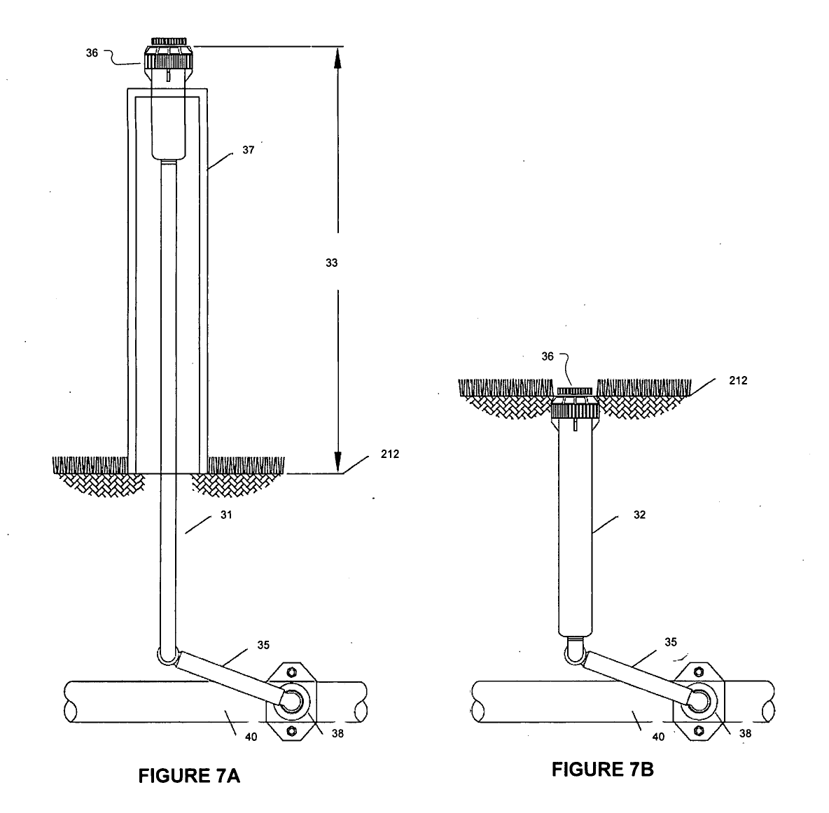

FIG. 6 is a diagram of a sprinkler distribution pattern according to various embodiments. In the embodiment the sprinklers 30 have a maximum distribution radius of 75 feet over 180 degrees and are spaced 100 feet a apart so they have an overlap 34 of at least 25 feet. FIG. 7A is a diagram of a raised sprinkler 31 and FIG. 7B is a diagram of a ground level, pop-up sprinkler 32. The raised sprinkler 31 has a base height 33 above a finish grade 212. The sprinklers 31, 32 heads 36 are coupled to the piping 40 via the mechanical tee 38 and swing joint 35. The head 36 of sprinkler 32 may extend or pop-up from base when liquid is projected from the head 36. Such head extension of sprinkler 32 may enable a sprinkler 32 to spray dispersed liquid over a larger area.

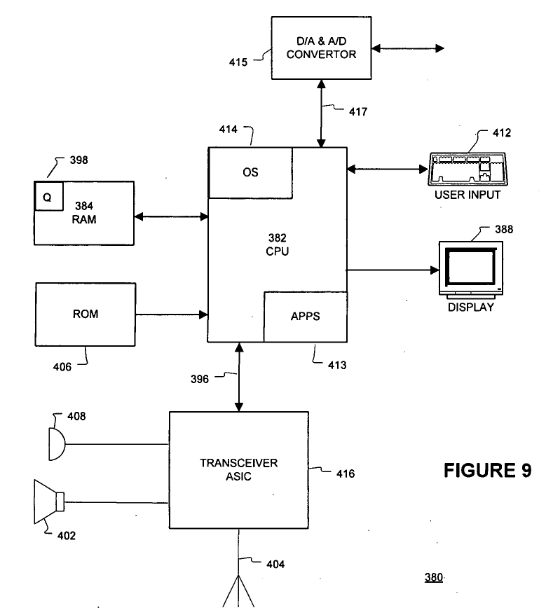

FIG. 9 is a block diagram of an article 380 according to various embodiments. The article 380 shown in FIG. 10 may be used in various embodiments as a part of a fire retardation system 20 where the article 380 may be any computing device including a personal data assistant, cellular telephone, laptop computer, or desktop computer. The article 380 may include a central processing unit (CPU) 382, a random access memory (RAM) 384, a read only memory (ROM″) 406, a display 388, a user input device 412, a transceiver application specific integrated circuit (ASIC) 416, a digital to analog (D/A) and analog to digital (A/D) convertor 415, a microphone 408, a speaker 402, and an antenna 404. The CPU 382 may include an OS module 414 and an application module 413. The RAM 384 may include a queue 398 where the queue 398 may store signal levels to be applied to or monitored on one or more bipolar modules. The OS module 414 and the application module 413 may be separate elements. The OS module 414 may execute a computer system or controller OS. The application module 412 may execute the applications related to the control of a system 20.

The ROM 406 is coupled to the CPU 382 and may store the program instructions to be executed by the CPU 382, OS module 414, and application module 413. The RAM 384 is coupled to the CPU 382 and may store temporary program data, overhead information, and the queues 398. The user input device 412 may comprise an input device such as a keypad, touch pad screen, track ball or other similar input device that allows the user to navigate through menus in order to operate the article 380. The display 388 may be an output device such as a CRT, LCD, LED or other lighting apparatus that enables the user to read, view, or hear user detectable signals.

The microphone 408 and speaker 402 may be incorporated into the device 380. The microphone 408 and speaker 402 may also be separated from the device 380. Received data may be transmitted to the CPU 382 via a bus 396 where the data may include signals for a bipolar module or optical module. The transceiver ASIC 416 may include an instruction set necessary to communicate data, screens, or signals. The ASIC 416 may be coupled to the antenna 404 to communicate wireless messages, pages, and signal information within the signal. When a message is received by the transceiver ASIC 416, its corresponding data may be transferred to the CPU 382 via the serial bus 396. The data can include wireless protocol, overhead information, and data to be processed by the device 380 in accordance with the methods described herein.

The D/A and A/D convertor 415 may be coupled to one or more bipolar modules and optical modules to generate a signal to be used to energize one of the bipolar modules and optical modules. The D/A and A/D convertor 415 may also be coupled to one devices and enable the activation of the motor 138.

Any of the components previously described can be implemented in a number of ways, including embodiments in software. Any of the components previously described can be implemented in a number of ways, including embodiments in software. Thus, the pump station 20, piping 40, sprinklers 30, and sensors 80 may all be characterized as “modules” herein. The modules may include hardware circuitry, single or multi-processor circuits, memory circuits, software program modules and objects, firmware, and combinations thereof, as desired by the architect of the system 10, 100 and as appropriate for particular implementations of various embodiments. The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, vehicles, and others. Some embodiments may include a number of methods. It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

1. A large scale outdoor based fire protection system for retarding wildfire expansion through a natural fuel region to a region to be protected, including:
a pump station including a liquid based pump;
a plurality of large flow rate liquid sprinklers, the sprinklers distributed in sections between or about the natural fuel region and the region to be protected;
a plurality of liquid piping coupling the plurality of the large flow rate liquid sprinklers to the pump station; and
a large liquid volume storage tank storing liquid based fire retardant material, the storage tank coupled to the pump,
wherein upon pump activation the fire retardant material is dispersed via the piping and sprinklers to cover a continuous section of the natural fuel region adjacent the region to be protected.

2. The fire protection system according to claim 1, further including a first fire detection sensor coupled to the pump station and located at or near one of the natural fuel region and the region to be protected.

3. The fire protection system according to claim 2, the pump station further including a controller coupled to the liquid based pump and the fire detection sensor and activating the liquid based pump based on the fire detection sensor.

4. The fire protection system according to claim 3, the fire detection sensor monitoring one of temperature, gas content, ultraviolet energy, and infra-red energy at or near the fire detection sensor.

5. The fire protection system according to claim 3, further including a second fire detection sensor coupled to the pump station and located at or near one of the natural fuel region and the region to be protected.

6. The fire protection system according to claim 2, the pump station further including a controller coupled to the liquid based pump and the first and the second fire detection sensor and activating the liquid based pump based on the first and the second fire detection sensor.

7. The fire protection system according to claim 2, the large liquid volume storage tank at least partially subterranean.

8. The fire protection system according to claim 2, at least one of the sprinklers extending vertically upon activation.

9. The fire protection system according to claim 2, the piping extending from 500 to 200,000 linear feet.

10. The fire protection system according to claim 2, the storage tank storing 3,000 to 250,000 liquid gallons.

11. The fire protection system according to claim 2, the plurality of sprinklers dispersing 30 to 150 liquid gallons per minute upon activation.

12. The fire protection system according to claim 2, the plurality of sprinklers dispersing liquid from a 50 to 150 foot distance from each sprinkler.

13. The fire protection system according to claim 2, the pump moving liquid from 250 to 5000 gallons per minute upon activation.

14. The fire protection system according to claim 13, the pump including at least one of an electric motor and a fuel based engine.

15. The fire protection system according to claim 13, wherein the fire retardant is chemically based.

16. A large scale outdoor based fire protection method for retarding wildfire expansion through a natural fuel region to a region to be protected, including:
deploying a pump station including a liquid based pump;
deploying a plurality of large flow rate liquid sprinklers, the sprinklers distributed in sections between or about the natural fuel region and the region to be protected;
deploying a plurality of liquid piping coupling the plurality of the large flow rate liquid sprinklers to the pump station;
deploying a large liquid volume storage tank storing liquid based fire retardant material, the storage tank coupled to the pump; and
activating the pump to disperse the fire retardant material to cover a continuous section of the natural fuel region adjacent the region to be protected.

17. The fire protection method according to claim 16, further including a first fire detection sensor coupled to the pump station and located at or near one of the natural fuel region and the region to be protected.

18. The fire protection method according to claim 17, the pump station further including a controller coupled to the liquid based pump and the fire detection sensor and activating the liquid based pump based on the fire detection sensor.

19. The fire protection method according to claim 18, the fire detection sensor monitoring one of temperature, gas content, ultraviolet energy, and infra-red energy at or near the fire detection sensor.

20. The fire protection method according to claim 18, further including a second fire detection sensor coupled to the pump station and located at or near one of the natural fuel region and the region to be protected.

21. The fire protection method according to claim 17, the pump station further including a controller coupled to the liquid based pump and the first and the second fire detection sensor and activating the liquid based pump based on the first and the second fire detection sensor.

22. The fire protection method according to claim 17, the large liquid volume storage tank at least partially subterranean.

23. The fire protection method according to claim 17, at least one of the sprinklers extending vertically upon activation.

24. The fire protection method according to claim 17, the piping extending from 500 to 200,000 linear feet.

25. The fire protection method according to claim 17, the storage tank storing 3,000 to 250,000 liquid gallons.

26. The fire protection method according to claim 17, the plurality of sprinklers dispersing 30 to 50 liquid gallons per minute upon activation.

27. The fire protection method according to claim 17, the plurality of sprinklers dispersing liquid from a 50 to 150 foot distance from each sprinkler.

28. The fire protection method according to claim 17, the pump moving liquid from 250 to 5000 gallons per minute upon activation.

29. The fire protection method according to claim 28, the pump including at least one of an electric motor and a fuel based engine.

30. The fire protection method according to claim 29, wherein the fire retardant is chemically based.
